(19) United States
(12) Patent Application Publication
(10) Pub. No.: US 2019/0257281 A1
(43) Pub. Date: Aug. 22, 2019

(54) BI-DIRECTIONAL SCALABLE TURBINE

(71) Applicant: Ralph Dominic RAINA, Kemptville (CA)

(72) Inventor: Ralph Dominic RAINA, Kemptville (CA)

(21) Appl. No.: 16/280,735

(22) Filed: Feb. 20, 2019

Related U.S. Application Data
(60) Provisional application No. 62/633,696, filed on Feb. 22, 2018.

(51) Int. Cl. F03B 3/18; F03B 3/12; F03B 15/04

(52) U.S. Cl. CPC F03B 3/183; F03B 3/121; F05B 2240/13; F05B 2220/32; F03B 15/04

(57) ABSTRACT

The present invention provides a simple and effective passive turbine unit that uses the flow of water or air to rotate a main runner and produce continuous and intermittent electricity from streams, rivers, tidal water and high wind areas. The turbine unit may be installed as an individual unit or in combination with other turbine units. In an alternative configuration the turbine units may be stacked on top of one another. The turbine units are capable of working in a bi-directional flow of water or air, and are scalable to meet the needs of a user. The turbine unit is particularly suited for use within undeveloped areas that do not have access to electricity but do have access to streams, rivers, tidal waters, or high wind areas.

### FIELD

The present invention pertains to the field of turbines and in particular to single or bi-directional, scalable water turbines.

### BACKGROUND

Electricity can be generated in many different ways. Electricity can be harvested from coal, nuclear, oil, solar, geothermal, wind and hydro. Some of these electricity sources are environmentally hazardous, and/or non-renewable. They also require large financial investment and/or a large physical footprint.

When flowing water runs through a turbine, electricity is generated. The energy stored within flowing water turns a runner of the turbine. As the runner turns it rotates a turbine shaft, which causes a generator connected to the shaft to spin also. The generator converts the mechanical energy from the turbine into hydroelectric energy.

Hydroelectric power stations are typically built on rivers. The turbines used within these stations are industrial size and can be housed within large dam structures. These power stations are expensive to build and operate, and have significant environmental impact.

Turbines are also used to generate electricity in tidal waters. Historically, tidal turbines require a minimum depth of water to function. Once the turbine is positioned within a depth of seven (7) meters (or twenty (20) feet) of water, the tidal water will start flowing through the turbine, creating electricity. These turbines are expensive to manufacture and maintain.

The common turbine design functions on the vertical plane, using inlet and outlet gates that permit water to enter at a high point, and exit through a low point.

Therefore, there is a need for a water turbine that is not subject to one or more limitations of the prior art.

This background information is provided to reveal information believed by the applicant to be of possible relevance to the present turbine. No admission is necessarily intended, nor should be construed, that any of the preceding information constitutes prior art against the present turbine.

### BRIEF SUMMARY

An object of the present invention is to provide single or bi-directional scalable turbine. In accordance with an aspect of the present invention, there is provided turbine for the generation of electricity comprising a main runner comprising, a main runner hub, and at least two main runner blades; a main runner shaft; and a main runner housing chamber comprising, a water inlet, an adjustable water inlet guide gate, and a water outlet.

### BRIEF DESCRIPTION OF THE FIGURES

Embodiments of the present invention will be better understood in connection with the following Figures, in which:

FIG. 1 illustrates a top view of the bi-directional turbine;

FIG. 2 illustrates a perspective view of the bi-directional turbine;

FIG. 3 illustrates a top view of the directional turbine in a singular direction configuration;

FIG. 4 illustrates a top view of the bi-directional turbine, without the use of the main runner housing chamber water outlet and inlet guide arms; and

FIG. 5 illustrates an expanded view of the bi-directional turbine assisted by the use of rails, wheels, and an anchor cable for the purposes of being able to move the turbine.

FIG. 6 illustrates an embodiment of a single directional turbine with pressure release.

### DETAILED DESCRIPTION

Unless defined otherwise, all technical and scientific terms used herein have the same meaning as commonly understood by one of ordinary skill in the art to which this invention belongs.

### Overview

The present invention provides a single-directional or bi-directional turbine that uses the flow of water to rotate a main runner and produce continuous and/or intermittent electricity. The turbine may use flowing water from streams, rivers, and/or tidal water. The turbine is suited for use within undeveloped areas that do not have access to electricity but do have access to a source of flowing water. The bi-directional turbine is particularly suited for use in tidal waters.

The turbine is configured to be single or uni-directional or bi-directional. Optionally, bi-directional turbines are configured to be as aqua-dynamic as possible to reduce or eliminate drag from the surging tide.

In another embodiment, the turbine uses the flow of air in high wind areas to rotate a main runner and produce continuous and/or intermittent electricity.

In one embodiment, the turbine includes a main runner comprising a main runner hub, and at least two main runner blades; a main runner shaft; a main runner housing chamber comprising a water inlet, an adjustable water inlet guide gate, and a water outlet.

In one embodiment, the turbine includes a main runner hub, and at least two main runner blades; a main runner shaft; a main runner housing chamber comprising a water inlet, an adjustable water inlet guide gate, adjustable water outlet guide gate and a water outlet.

In one embodiment, the turbine is comprised of a main runner hub, and at least two main runner blades; a main runner shaft; a main runner housing chamber comprising a water inlet, an adjustable water inlet guide gate, adjustable water outlet guide gate and a water outlet; at least one main runner housing chamber water inlet guide arm; and at least one main runner housing chamber water outlet guide arm.

The turbine is optionally scalable to suit the specific needs of the user. It may be configured to fit within a small stream for general public use, or it may be configured to be industrial sized for use within large rivers or oceans. It may produce electricity in amounts as little as 100 watts, to as much as megawatts. When scaled to embody a small unit, the turbine may be used to charge batteries, power a light or cooking mechanism, or otherwise as would be understood by someone skilled in the art. When scaled to embody a large unit, the turbine may be used to contribute electricity into a power grid, power industrial sites, or otherwise as would be understood by someone skilled in the art.

In one embodiment, the turbine is configured to be easily removable and portable. In this configuration the turbine may be used seasonally, during specific water flow strengths or patterns, or may be used in different water flow sources at different times.

In an additional embodiment, the turbine is installed in cooperation with a secondary mechanism such as rails, guides, lifts, or otherwise as would be understood by someone skilled in the art. For example, the turbine could be installed upon a set of rails within a water source, and may be moved accordingly within the source to maximize efficiency of the energy production of the turbine.

In another embodiment, the turbine is installed within a canal or dam system to aid in the production of electricity. For example, canal gates could be installed on tributaries in tidal water areas. The canal gates could be open as a tributary fills with water from an incoming tide. Once the tide reaches full height, the gates could be closed, and as the tide recedes water is trapped within the tributary. The turbine user may then select when to open a secondary canal gate to which a turbine is installed. This would also provide the user control over the water, allowing them to determine water flow at a given rate or volume suited to work with the specific turbines installed upon the secondary canal gates. In this way, energy production could be maximized, and the turbine are able to generate power while tides are out.

In one embodiment, the turbine is configured such that repair or maintenance of the turbine is simple. The working parts within the turbine of such an embodiment are easily accessible, and the main runner housing chamber may be made of translucent material so that the interior working parts of the turbine can be monitored externally.

In one embodiment, the turbine will produce electricity in shallow water, a depth as shallow as half (½) a meter (or one (1) foot) of water. The scalable nature of the turbine will provide for the ability to produce small turbines that are of a size that is able to fit within small streams. An additional benefit of a smaller scale version of the turbine is the ability to function within very shallow tidal waters. This will allow a bi-directional turbine to collect electricity in smaller tidal zones, as well as during the entire tidal cycle.

In another embodiment, the main runner housing chamber of the turbine helps to reduce the dangers to wildlife caused by water or wind turbines. The main runner housing chamber will prevent wildlife from exposure to the spinning blades of the turbine.

In one embodiment, the BDT is configured to use the flow of water in a bi-directional manner to rotate a main runner and produce electricity. This configuration is specifically suited for water flow sources that flow in a two directions, such as tidal waters.

In one embodiment, the single or uni-directional turbine is configured to uses the flow of water in a singular direction to rotate a main runner and produce electricity. This configuration is specifically suited for water flow sources that flow in a single direction, such as a river.

In one embodiment, the turbine is configured to produce electricity as an individual unit. A single turbine will be installed and may produce electricity directly dependent on the size of the turbine, and the source of the flowing water.

In another embodiment, the turbine is configured to product electricity in combination with other turbines. The turbines may be installed together, and/or in parallel or series, to produce larger amounts of electricity. The exact configuration of the turbines will be dependent on the user and environmental limitations.

In one embodiment, multiple turbines are configured so they are stackable. This configuration is particularly useful for the generation of electricity within tidal waters. In the stacked configuration, the turbines will have a small physical footprint upon the ocean floor. This configuration will also allow the turbines to generate electricity at different water depths (as the tide comes in and goes out). Each turbine in the stack configuration may be used once the tide level reaches the depth of the specific turbine in the stack.

In one embodiment, the bi-directional turbine is configured to generate electricity regardless of the direction that the water flows through the turbine. The water inlet may become the water outlet, and the water outlet may become the water inlet depending on the direction of the water flow.

In one embodiment, the turbine is configured to produce electricity in combination with the use of a generator as would be understood by someone skilled in the art.

In one embodiment, the turbine is configured to be anchored to a surface as would be understood by someone skilled in the art.

In one embodiment, the turbine is manufactured and sold by a turbine provider. turbine parts may be sold individually, or within a kit. The turbine provider may also charge for services related to the turbine such as installation, maintenance, energy generation design, monitoring or otherwise as would be understood by someone skilled in the art.

### Main Runner and Shaft

In one embodiment, the main runner comprising a main runner hub and at least two main runner blades, is attached to a main runner shaft. When water flows through the turbine, it puts pressure on the main runner blades, rotating the main runner hub, and consequently the main runner shaft. The rotation of the main runner shaft causes a generator connected to the shaft to also spin. The generator converts the mechanical energy from the turbine into electric energy.

In one embodiment, the main runner hub, main runner blades and main runner shaft are comprised of metal, plastic, composite, rubber, or other material as would be understood by someone skilled in the art. In an additional embodiment each of these elements may be comprised of a combination of these materials.

In one embodiment, the main runner hub, main runner blades and main runner shaft is comprised of the same material. In an additional embodiment, each of these elements may be comprised of different materials.

In one embodiment, the main runner is positioned within the main runner housing chamber such that the main runner blades rotate around a vertical axis. The main runner shaft is configured to attach to a generator as would be understood by someone skilled in the art.

In one embodiment, the main runner is positioned within the main runner housing chamber such that the main runner blades rotate around a horizontal axis. The main runner shaft is configured to attach to a generator as would be understood by someone skilled in the art.

In one embodiment, the user will select a specific number of main runner blades to use in the turbine. The number of blades selected may correspond to perform at optimal efficiency based on the conditions in which the turbine is operating.

In another embodiment, the user will select a certain shape of main runner blades to use upon the turbine. The shape of the blades selected may correspond to perform at optimal efficiency based on the conditions in which the turbine is operating.

In another embodiment, the user will select a certain tilt of main runner blades to use upon the turbine. The tilt of the blades selected may correspond to perform at optimal efficiency based on the conditions in which the turbine is operating. The tilt of the blades may be optionally adjustable so as to further perform at optimal efficiency based on the conditions in which the turbine is operating. Control of the tilt of the blades may be automatic based on the water flow conditions, or may be manually controlled.

In one embodiment, the turbine utilizes at least one secondary turbine runner. The at least one secondary turbine runner will comprise a secondary runner hub and at least two secondary main runner blades, which will be attached to a secondary runner shaft. The at least one secondary turbine runner will be housed within the main runner housing, but at a different location to the main runner. The at least one secondary turbine runner may be used to produce additional electricity using unused water flow passing through the turbine.

### Main Runner Housing Chamber and Adjustable Guide Gates

The main runner housing chamber will house the main runner. It will include a water inlet, an adjustable water inlet guide gate, an adjustable water outlet guide gate, and a water outlet.

In one embodiment, the main runner housing chamber will be a rectangular prism in shape, and configured to have dimensions that are able to accommodate the main runner and adjustable guide gates. The water inlet is located at the first distal face of the rectangular prism, and the water outlet is located at the second distal face of the rectangular prism.

In another embodiment, the main runner housing chamber is rectangular in shape, and configured to have dimensions that are able to accommodate the main runner, the adjustable guide gates, and at least one secondary runner. The water inlet is located at the first distal face of the rectangular prism, and the water outlet is located at the second distal face of the rectangular prism.

In one embodiment, the main runner housing chamber has a shape and dimensions to suit the specific needs of the user.

In another embodiment, the turbine is configured to such that any surface of the housing chamber may be used to secure the turbine. The turbine orientation may be determined prior to installation, and the corresponding housing chamber surface used to install the BDT. In this configuration the functionality of the turbine may be altered depending on the housing chamber surface used to install the turbine.

In one embodiment, the main runner housing chamber is comprised of metal, plastic, composite, natural material or otherwise as would be understood by someone skilled in the art.

In one embodiment, the main runner housing chamber houses an adjustable water inlet guide gate on an interior surface of the rectangular prism. The adjustable water inlet guide gate is attached to the interior surface of the rectangular prism and will direct water flow into the main runner. The main runner housing chamber also houses an adjustable water outlet guide gate on an interior surface of the rectangular prism. The adjustable water outlet guide gate will be attached to the opposite interior surface of the rectangular prism to that of the attached adjustable water inlet guide gate. It is also be attached on the opposite side of the main runner. The adjustable water outlet guide gate directs water flow after it has run through the main runner.

In one embodiment, the adjustable water inlet guide gate and adjustable water outlet guide gate extends and/or retracts within the main runner housing chamber. The extension and retraction of the adjustable water guide gates is optionally in response to the water flow within the BDT. As they extend and/or retract, the adjustable water guide gates will act to optimize water flow through the BDT in order to produce electricity at the most efficient rate.

In one embodiment, the control of the adjustable water inlet guide gate and adjustable water outlet guide gate will be automatic, in response to the water flow. The automatic control may be based on timing, water flow strength, water flow direction, tidal clock, or otherwise as would be understood by someone skilled in the art.

In another embodiment, the control of the adjustable water inlet guide gate and adjustable water outlet guide gate is as directed by the user.

In another embodiment, the adjustable water inlet guide gate and adjustable water outlet guide gate extends and/or retracts in response to a change in the direction of water flow through the turbine. This allows the turbine to work with bi-directional water flow. This functionality is particularly useful when the turbine is installed within tidal waters. When in this configuration, the turbine will be able to generate electricity as the tide comes in, and the water flows through the turbine from the ocean to the shore. When in this configuration, the turbine will be also able to generate electricity as the tide goes out, and the water flows through the turbine from the shore to the ocean. In this configuration, when the tide reverses the water inlet becomes the water outlet, and the water outlet becomes the water inlet.

In one embodiment, the adjustable water inlet guide gate, and adjustable water outlet guide gate is comprised of metal, plastic, composite, natural material or otherwise as would be understood by someone skilled in the art

In one embodiment, the adjustable water inlet guide gate, and adjustable water outlet guide gate have a shape and dimensions to suit the specific needs of the user.

In one embodiment, the adjustable water inlet guide gate, and adjustable water outlet guide gate is comprised of the same material. In an additional embodiment, each of these elements is comprised of different materials.

In another embodiment, the main runner housing chamber is comprised of water inlet, an adjustable water inlet guide gate, and a water outlet to be optimized for use of the turbine in body of water that has a singular direction of water flow. In this configuration an adjustable water outlet guide gate is not required or utilized.

In one embodiment, the main runner housing chamber is a rectangular prism in shape, and configured to have dimensions that are able to accommodate multiple main runners and corresponding adjustable guide gates. The water inlet is located at the first distal face of the rectangular prism, and the water outlet is located at the second distal face of the rectangular prism. Each of the main runners within the main runner housing chamber may be configured to power the same drive shaft.

In another embodiment, the main runner housing chamber also accommodates secondary water inlets along the surface of the main runner housing chamber. These secondary water inlets will allow additional water to flow into the main runner housing chamber to provide additional water flow to the multiple main runners and corresponding adjustable guide gates. The secondary water inlets may be situated within the main runner housing chamber as designed by the turbine user in order to best suit the water flow conditions of a particular site.

In another embodiment, the secondary water inlets may be aided by at least one main runner housing chamber secondary water inlet guide arm to help direct water into the main runner housing chamber.

### Water Inlet and Outlet Guide Arms

In one embodiment, the main runner housing supports at least one main runner housing chamber water inlet guide arm, and at least one main runner housing chamber water outlet guide arm. The at least one main runner housing chamber water inlet guide arm will be attached to the main runner housing at the water inlet. The at least one main runner housing chamber water outlet guide arm will be attached to the main runner housing at the water outlet.

In another embodiment, the at least one main runner housing chamber water inlet guide arm, and at least one main runner housing chamber water outlet guide arm will direct additional water flow into the turbine.

In another embodiment, the at least one main runner housing chamber water inlet guide arm, and at least one main runner housing chamber water outlet guide arm is fixed to the main runner housing.

In another embodiment, the at least one main runner housing chamber water inlet guide arm, and at least one main runner housing chamber water outlet guide arm will be adjustable. The guide arms extend and/or retract in response to the water flow towards or out of the turbine. As the guide arms extend and/or retract, they act to optimize water flow into and out of the turbine in order to produce electricity at the most efficient rate.

In one embodiment, the control of the guide arms is automatic, in response to the water flow. The automatic control may be based on timing, water flow strength, water flow direction, tidal clock, or otherwise as would be understood by someone skilled in the art.

In another embodiment, the control of the guide arms is as directed by the user.

In one embodiment, the guide arms are comprised of metal, plastic, composite, natural material or otherwise as would be understood by someone skilled in the art

In one embodiment, the guide arms have a shape and dimensions to suit the specific needs of the user.

In one embodiment, the guide arms are comprised of the same material. In an additional embodiment, each of these elements are comprised of different materials.

In one embodiment, the main runner housing will not utilize a main runner housing chamber water inlet or outlet guide arm. The main runner housing will not support either of a main runner housing chamber water inlet guide arm, or a main runner housing chamber water outlet guide arm. In another embodiment, the main runner housing will utilize only one of a main runner housing chamber water inlet or outlet guide arm.

### Control Mechanism

In one embodiment, the turbine will use a control mechanism to automatically control, adjust and monitor the BDT. In another embodiment, the turbine control mechanism will allow a user to control, adjust and monitor the turbine.

In another embodiment, the turbine control mechanism will be enabled for remote monitoring and/or use. The turbine control mechanism will accommodate secondary monitoring and/or functionality components, such as but not limited to a computing device interface and/or communication module, location interface, or other component as would be understood by someone skilled in the art. In this way the turbine functionality and/or use may be controlled, tracked, monitored, and/or stored remotely for the purposes of turbine functionality, and/or analysis of turbine behavior.

The turbine will now be described with reference to specific examples. It will be understood that the following examples are intended to describe embodiments of the turbine and are not intended to limit the turbine in any way.

### Examples

In a first example, it is contemplated that an energy entity “Tidal Power” elects to utilize a bi-directional turbine to collect energy from tidal waters off the east coast of Canada. Tidal Power installs a large-scale bi-directional turbine in a tidal area. The bi-directional turbine is designed and scaled to be suited for the particular location it is being installed. Once the bi-directional turbine is installed, Tidal Power uses the bi-directional turbine to run a generator and produce electricity. As the tide comes in, the bi-directional turbine main runner housing chamber uses an adjustable water inlet guide gate on an interior surface of the housing chamber to channel the incoming tidal waters over the main runner. The adjustable water outlet guide gate on an interior surface of the housing chamber is in a ‘closed position, such that it is laying flat against the interior surface of the housing chamber. This process continues while the tide continues to rise. When the tide shifts, and water begins to flow away from the shoreline, the configuration of the bi-directional turbine shifts. The adjustable water inlet guide gate on an interior surface of the housing chamber will shift its position to a ‘closed position’, where it lays flat against the interior surface of the housing chamber. Simultaneously, the adjustable water outlet guide gate shifts its configuration from a ‘closed position’ to open, such that it directs the outgoing tidal waters over the main runner. In this configuration, the adjustable water guide gates shift their configuration as the tidal waters shift from incoming to outgoing, and vice-versa. Tidal Power is able to use the bi-directional turbine to generate electricity throughout the entire tidal cycle.

In an alternative to the first example, it is contemplated that Tidal Power decides to install multiple bi-directional turbines stacked upon one another. As the tidal waters come in, the stack configuration of bi-directional turbines allows for additional electricity to be generated. As the water rises, a second bi-directional turbine stacked upon a first bi-directional turbine will be engaged by the water. The stack of bi-directional turbines may be configured such that the number of BDTs in the stack will correlate to the height of the tide. Each bi-directional turbine in the stack will be engaged as the tide rises, and each bi-directional turbine will generate electricity as it is engaged. Once the tide shifts and water flows away from shore, bi-directional turbines will be disengaged sequentially, from the top bi-directional turbine in the stack down.

In another alternative to the first example, it is contemplated that Tidal Power decides to install the bi-directional turbine upon a set of rails. The bi-directional turbine rails may run perpendicular to the shoreline such that the bi-directional turbine can be run to and from shore into and out of the tidal waters. Tidal Power may use this system to position the bi-directional turbine in a specific location within the tidal waters to most efficiently generate electricity. It will also allow Tidal Power to easily inspect and maintain the bi-directional turbine upon shore, as well as to remove the bi-directional turbine entirely from the tidal waters for the purposes of aesthetics.

In a second example, it is contemplated that a small-scale turbine is designed to be portable. A hiker “Kyle” acquires the turbine prior to a long hiking trip in the Rocky Mountains. As the turbine is scaled to be small and portable, Kyle packs the turbine in his gear. Once Kyle reaches a campsite, he places the turbine in a nearby stream. The turbine is configured to charge a battery pack that can provide power to numerous electrical devices, such as lights, phones, cooking gear, etc. In this way Kyle is able to charge electrical goods while he is in the wilderness away from traditional power sources.

In a third example, it is contemplated that Eileen owns a hunting cabin in a remote area, which does not have access to electricity. There is a moderate river that runs nearby the hunting cabin, and Eileen decides to purchase a moderate scaled turbine. She installs the turbine within the river and uses the turbine to run a generator next to her cabin. The generator produces electricity and is able to power certain appliances within the cabin, such as a stove, fridge, and washing machine. In this way the turbine has provided electricity to Eileen's remote cabin.

In a fourth example, it is contemplated that an environmentally conscious energy entity “Friendly Flow” elects to utilize bi-directional turbines to collect energy. Friendly Flow decides to configure the bi-directional turbines such that a large main runner housing chamber is constructed and anchored to the sea floor of a tidal area in Australia. The main runner housing chamber is about 3 meters in depth, about 3 meters wide, and about 100 meters long. It accommodates several main runners, positioned one behind each other to utilize the same flowing current. It also accommodates several secondary water inlets throughout the surface of the main runner housing chamber. In this configuration a population of whales that frequents the tidal is protected from exposure to the spinning blades of the main runners within the bi-directional turbines. This configuration also allows the collective working of multiple main runners the ability to overcome large resistance on a drive shaft. Each of the main runners are connected to the same drive shaft that runs from the bi-directional turbines to a Friendly Flow generator stationed on land. Secondary water inlet guide arms are positioned beside the secondary water inlets on the main runner housing chamber to help funnel tidal flowing water into the bi-directional turbines. As the tidal waters flow in and out from the land, the BTDs collectively turn a single drive shaft and generate electricity for Friendly Flow that is fed into a power grid.

In a fifth example, it is contemplated that Heather owns a sailboat. She plans on taking the boat on a long journey and may spend several days on the water in a row without access to electricity. Heather decides to purchase a small scaled turbine to install on her sailboat. As she sails her boat, wind flows through the turbine and is able to produce electricity. She uses this electricity to power certain boat equipment including her navigation system and radio. In this way the turbine has provided electricity to Heather's sailboat during remote use.

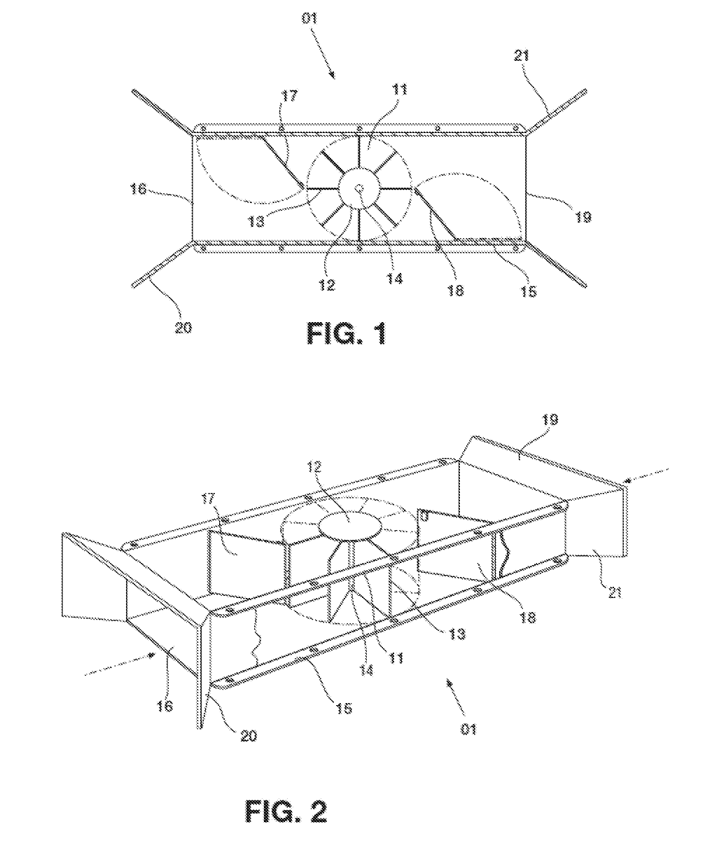

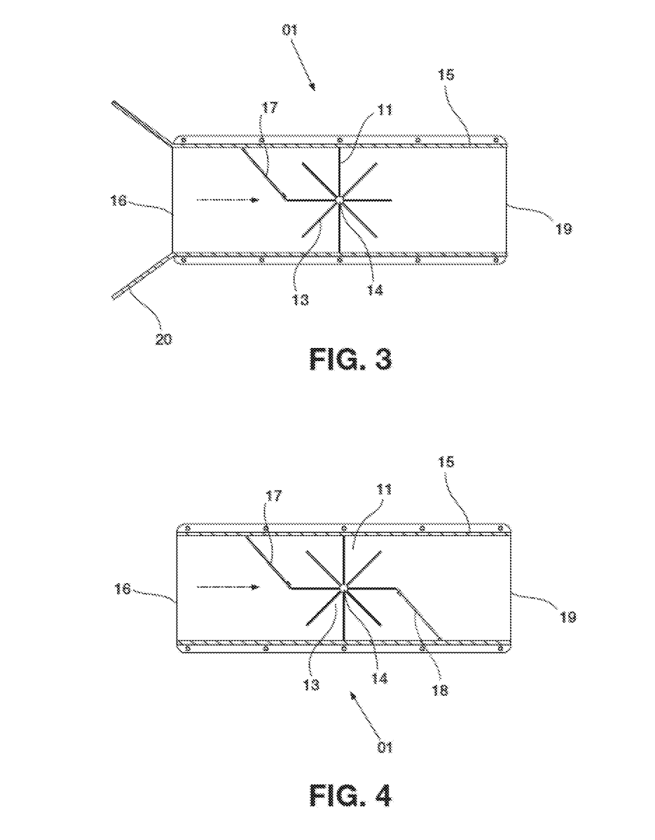

In one example of the bi-directional turbine as depicted in FIGS. 1, 2, 3 and 4, the bi-directional turbine 01 is provided. The main runner 11 of the turbine consists of a main runner hub 12 and at least two main runner blades 13. As the main runner is rotated by the flow of water through the bi-directional turbine, it rotates a main runner shaft 14. The turbine is kept within the main runner housing chamber 15. Water enters the main runner housing chamber though a water inlet 16, where it is directed towards the main runner using an adjustable water inlet guide gate 17. Once the water has passed through the main runner, it leaves the main runner housing chamber through an adjustable water outlet guide gate 18, and a water outlet 19. There is at least one main runner housing chamber water inlet guide arm 20 attached to the main runner housing chamber at the water inlet. There is also at least one main runner housing chamber water outlet guide arm 21 attached to the main runner housing chamber at the water outlet.

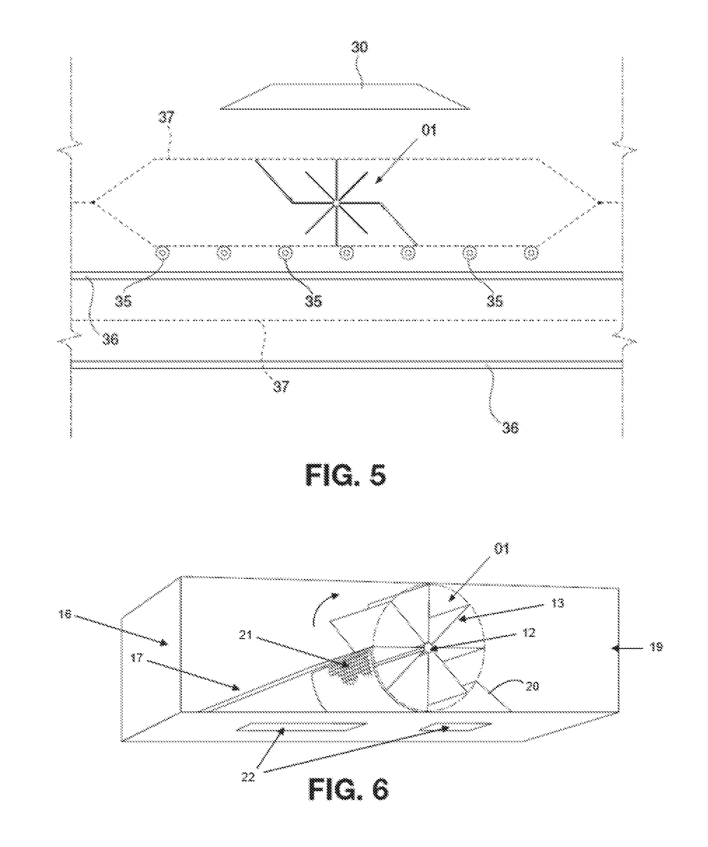

In another example of the bi-directional turbine as depicted in FIG. 5, the bi-directional turbine 01 is provided. The bi-directional turbine is mounted to wheels 35 which may be mounted upon rails 36. An anchor cable 37 may be placed under the turbine and anchored into bedrock to help pull the bi-directional turbine along the rails.

Referring to FIG. 6, a single directional turbine 01 is provided. The main runner 11 of the turbine consists of a main runner hub 12 and at least two main runner blades 13. As the main runner is rotated by the flow of water through the single-directional turbine, it rotates a main runner shaft 14. Water enters the main runner housing chamber though a water inlet 16, where it is directed towards the main runner using a water inlet guide 17. Once the water has passed through the main runner, the majority of it leaves the main runner housing chamber through a water outlet 19. There is at least one main runner housing chamber water inlet guide arm 20 attached to the main runner housing chamber at the water inlet. Any water that does not exit through the water outlet 19 escapes through mesh 21 and exits through openings 22 in the housing.

It will be appreciated that, although specific embodiments of the turbine have been described herein for purposes of illustration, various modifications may be made without departing from the spirit and scope of the invention. In particular, it is within the scope of the turbine to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure some or all of its components in accordance with the system of the turbine.

Acts associated with the turbine described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the turbine described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, personal communication device, server, PDA, or the like and pursuant to one or more, or a part of one or more, program elements, modules or objects generated from any programming language, such as C++, Java, PL/1, or the like. In addition, each step, or a file or object or the like implementing each said step, may be executed by special purpose hardware or a circuit module designed for that purpose.

It is obvious that the foregoing embodiments of the turbine are examples and can be varied in many ways. Such present or future variations are not to be regarded as a departure from the spirit and scope of the turbine, and all such modifications as would be obvious to one skilled in the art are intended to be included within the scope of the following claims.

The scope of the claims should not be limited by the preferred embodiments set forth in the examples, but should be given the broadest interpretation consistent with the description as a whole.

We claim:

1. A turbine for generation of electricity comprising:
a main runner comprising;
a main runner hub; and
at least two main runner blades;
a main runner shaft; and
a main runner housing chamber comprising;
a water inlet;
an adjustable water inlet guide gate; and
a water outlet.

2. The turbine of claim 1, wherein the main runner housing chamber further comprises:
an adjustable water outlet guide gate.

3. The turbine of claim 1, wherein the main runner housing chamber adjustable water inlet guide gate is automatically regulated, adjusted or controlled.

4. The turbine of claim 2, wherein the main runner housing chamber adjustable water outlet guide gate is automatically regulated, adjusted or controlled.

5. The turbine of claim 1, wherein the turbine further comprises:
at least one main runner housing chamber water inlet guide arm; and
at least one main runner housing chamber water outlet guide arm.

6. The turbine of claim 5, wherein the main runner housing water inlet guide arm and main runner housing water outlet guide arm are adjustable and may be automatically regulated, adjusted or controlled.

7. The turbine of claim 1, wherein the operation of the turbine is controlled by a control mechanism.

8. The turbine of claim 1, wherein the turbine further comprises:
at least one secondary runner comprising;
at least one secondary runner hub; and
at least two secondary runner blades.

9. The turbine of claim 1, wherein the turbine is configured to be anchored to a surface.

10. The turbine of claim 1, wherein the turbine is configured to be stackable upon another turbine.

11. The turbine of claim 1, wherein the turbine is configured to be moveable with the aid of wheels and rails.

12. The turbine of claim 1, wherein the main runner within is capable of powering a drive shaft attached to a generator.

13. The turbine of claim 1, wherein the main runner housing chamber is capable of housing multiple main runners and adjustable water inlet guide gates.

14. The turbine of claim 9, wherein each of the multiple main runners within the main runner housing chamber are capable of powering the same drive shaft attached to a generator.

15. The turbine of claim 9, wherein the main runner housing chamber also accommodates at least one secondary water inlet.

16. The turbine of claim 9, wherein the main runner housing chamber also accommodates at least one secondary water inlet guide arm.
